(19) United States
(12) Patent Application Publication
(10) Pub. No.: US 2006/0242213 A1
(43) Pub. Date: Oct. 26, 2006

(54) Variable Precision Processor

(76) Inventor: Paul B. Wood, Austin, TX (US)

Correspondence Address: LAW OFFICES OF MARK L. BERRIER, 3811 BEE CAVES ROAD, SUITE 204, AUSTIN, TX, 78746, US

(21) Appl. No.: 11/379,657

(22) Filed: Apr. 21, 2006

Related U.S. Application Data
(60) Provisional application No. 60/673,994, filed on Apr. 22, 2005.
(60) Provisional application No. 60/674,070, filed on Apr. 22, 2005.
(60) Provisional application No. 60/673,995, filed on Apr. 22, 2005.

(51) Int. Cl. G06F 13/00

(52) U.S. Cl. 708/160

(57) ABSTRACT

Systems and methods for processing variable precision data using tags to identify the positions of digits within data words. One embodiment comprises a processor having internal structures that are configured to represent a variable precision data word as a variable number of digits, where each digit includes a digit value and associated tags indicative of the digit's position within the data word. The digit value may comprise an 8-bit value, and the tags may include single bits indicating whether the digit is the first and/or last digit in the variable precision word. The processor may be coupled to other variable precision devices by variable precision communication channels. The processor may be coupled to external devices that represent with fixed precision, and may use aliases to provide mappings between the variable precision data and fixed precision data, automatically adding or removing the tags associated with the digits, as necessary.

### CROSS-REFERENCE TO RELATED APPLICATIONS

This application claims the benefit of U.S. Provisional Patent Application 60/673,994, filed Apr. 22, 2005, U.S. Provisional Patent Application 60/674,070, filed Apr. 22, 2005, and U.S. Provisional Patent Application 60/673,995, filed Apr. 22, 2005. All of the foregoing patent applications are incorporated by reference as if set forth herein in their entirety.

### BACKGROUND

1. Field of the Invention

The invention relates generally to electronic logic circuits, and more particularly to systems and methods for processing variable precision data using tags to identify the positions of digits within data words.

2. Related Art

As computer technologies have advanced, the amount of processing power and the speed of computer systems has increased. The speed with which software programs can be executed by these systems has therefore also increased. Despite these increases, however, there has been a continuing desire to make software programs execute faster.

The need for speed is sometimes addressed by hardware acceleration. Conventional processors re-use the same hardware for each instruction of a sequential program. Frequently, programs contain critical code in which the same or similar sections of software are executed many times relative to most other sections in an application. To accelerate a program, additional hardware is added to provide hardware parallelism for the critical code fragments of the program. This gives the effect of simultaneous execution of all of the instructions in the critical code fragment, depending on the availability of data. In addition, it may be possible to unroll iterative loops so that separate iterations are performed at the same time, further accelerating the software.

While there is a speed advantage to be gained, it is not free. Hardware must be designed specifically for the software application in question. The implementation of a function in hardware generally takes a great deal more effort and resources than implementing it in software. Initially, the hardware architecture to implement the algorithm must be chosen based on criteria such as the operations performed and their complexity, the input and output data format and throughput, storage requirements, power requirements, cost or area restrictions, and other assorted criteria.

A simulation environment is then set up to provide verification of the implementation based on simulations of the hardware and comparisons with the software. A hardware target library is chosen based on the overall system requirements. The ultimate target may be an application specific integrated circuit (ASIC), a field programmable gate array (FPGA), or other similar hardware platform. The hardware design then commences using a hardware description language (HDL), the target library, and the simulation environment. Logic synthesis is performed on the HDL design to generate a netlist that represents the hardware based on the target library.

While there are number of complex and expensive design tools employed throughout the process, frequent iterations are typically needed in order to manage tradeoffs, such as between timing, area, power and functionality. The difficulty of the hardware design process is a function of the design objectives and the target library. The continued advances in semiconductor technology continue to raise the significance of device parameters with each new process generation. That, coupled with the greater design densities that are made possible, ensures that the hardware design process will continue to grow in complexity over time.

This invention pertains to the implementation of algorithms in hardware—hardware that performs logic or arithmetic operations on data. Currently available methodologies range from using single processors, arrays of processors, either fixed (gate array) or field-programmable gate arrays (FPGA), or standard cell (ASIC) or full custom design techniques. Some designs may combine elements of more than one methodology. For example, a processor may incorporate a block of field programmable logic.

When comparing different implementations of programmable logic, the notion of granularity is sometimes used. It relates to the smallest programmable design unit for a given methodology. The granularity may range from transistors, through gates and more complex blocks, to entire processors. Another consideration in comparing programmable hardware architectures is the interconnect arrangement of the programmable elements. They may range from simple bit-oriented point-to-point arrangements, to more complex shared buses of various topologies, crossbars, and even more exotic schemes.

Full custom or standard cell designs with gate-level granularity and dense interconnects offer excellent performance, area, and power tradeoff capability. Libraries used are generally gate and register level. Design times can be significant due to the design flow imposed by the diversity of complex tools required. Verification after layout for functionality and timing are frequently large components of the design schedule. In addition to expensive design tools, manufacturing tooling costs are very high and climbing with each new process generation, making this approach only economical for either very high margin or very high volume designs. Algorithms implemented using full custom or standard cell techniques are fixed (to the extent anticipated during the initial design) and may not be altered.

The design methodology for fixed or conventional gate arrays is similar to that of standard cells. The primary advantages of conventional gate arrays are time-to-market and lower unit cost, since individual designs are based on a common platform or base wafer. Flexibility and circuit density may be reduced compared to that of a custom or standard cell design since only uncommitted gates and routing channels are utilized. Like those built with custom or standard cell techniques, algorithms implemented using conventional gate arrays are fixed and may not be altered after fabrication.

FPGAs, like conventional gate arrays, are based on a standard design, but are programmable. In this case, the standard design is a completed chip or device rather than subsystem modules and blocks of uncommitted gates. The programmability increases the area of the device considerably, resulting in an expensive solution for some applications. In addition, the programmable interconnect can limit the throughput and performance due to the added impedance and associated propagation delays. FPGAs have complex macro blocks as design elements rather than simple gates and registers. Due to inefficiencies in the programmable logic blocks, the interconnect network, and associated buffers, power consumption can be a problem. Algorithms implemented using FPGAs may be altered and are therefore considered programmable. Due to the interconnect fabric, they may only be configured when inactive (without the clock running). The time needed to reprogram all of the necessary interconnects and logic blocks can be significant relative to the speed of the device, making real-time dynamic programming unfeasible.

Along the continuum of hardware solutions for implementing algorithms lie various degrees of difficulty or specialization. This continuum is like an inverted triangle, in that the lowest levels require the highest degree of specialization and hence represent a very small base of potential designers, while the higher levels utilize more generally known skills and the pool of potential designers grows significantly (see Table 1.) Also, it should be noted that lower levels of this ordering represent lower levels of design abstraction, with levels of complexity rising in higher levels.

TABLE 1
Designer bases of different technologies

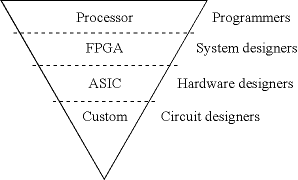

There is therefore a need for a technology to provide software acceleration that offers the speed and flexibility of an ASIC, with the ease of use and accessibility of a processor, thus enabling a large design and application base.

### SUMMARY OF THE INVENTION

This disclosure is directed to systems and methods for data processing that solve one or more of the problems discussed above. In one particular embodiment, a processor uses variable precision data that is represented internally by one or more digits, where each digit consists of a digit vale and one or more associated tags to identify the position of the digit within the corresponding data word.

One embodiment comprises a variable precision processor having internal structures that are configured to represent a variable precision data word as a variable number of digits, where each digit includes a digit value and associated tags indicative of the digit's position within the data word. In one embodiment, the digit value comprises an 8-bit value, and the tags include a 1-bit tag indicating whether the digit is the first digit in the variable precision word and a 1-bit tag indicating whether the digit is the last digit in the word. If both bits are set, the digit is the first and last (only) digit of the data word. If neither bit is set, the digit is intermediate to the first and last digits. The processor may be coupled to other devices (e.g., other variable precision processors) by variable precision communication channels. The processor may be coupled to external, conventional devices (e.g., fixed precision memory) and may represent data internally as multiple digits with associated tags, and externally as fixed precision data. Aliases may be used to provide mappings between the variable precision data and fixed precision data, so that the tags associated with the digits are automatically added or removed, as necessary.

Another embodiment may comprise a method implemented in a variable precision processor. In this method, variable precision data words are represented as variable numbers of digits. Each digit includes a digit value and associated tags indicating the digit's position within the data word. The digits are processed in a digit-serial fashion. The digit value may be represented as an 8-bit value, and the tags may be represented as single bits. For instance, a 1-bit tag may indicate whether the digit is the first digit in the variable precision word and a 1-bit tag may indicate whether the digit is the last digit in the word. Setting both bits indicates that the digit is the first and last (only) digit of the data word. Setting neither bit indicates that the digit is intermediate to the first and last digits. The method may include communicating variable precision data between the processor and other devices (e.g., other variable precision processors) using variable precision communication channels. The method may also include communicating variable precision data between the processor and external, conventional devices (e.g., fixed precision memory) and representing data internally as multiple digits with associated tags, and externally as fixed precision data. The method may further include mapping variable precision data to fixed precision data (and vice versa) and automatically adding or removing tags, as necessary.

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating how a data word is mapped into a series of digits and flag bits to form variable precision words in accordance with one embodiment.

FIG. 2 is a block diagram of a processor according to one embodiment of the invention.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF PREFERRED EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods for processing variable precision data using tags to identify the positions of digits within data words. One embodiment comprises a variable precision processor having internal structures that are configured to represent a variable precision data word as a variable number of digits, where each digit includes a digit value and associated tags indicative of the digit's position within the data word.

In one embodiment, the digit value comprises an 8-bit value, and the tags include a 1-bit tag indicating whether the digit is the first digit in the variable precision word and a 1-bit tag indicating whether the digit is the last digit in the word. If both bits are set, the digit is the first and last (only) digit of the data word. If neither bit is set, the digit is intermediate to the first and last digits. The processor may be coupled to other devices (e.g., other variable precision processors) by variable precision communication channels. The processor may be coupled to external, conventional devices (e.g., fixed precision memory) and may represent data internally as multiple digits with associated tags, and externally as fixed precision data. Aliases may be used to provide mappings between the variable precision data and fixed precision data, so that the tags associated with the digits are automatically added or removed, as necessary.

Conventional processors have fixed word sizes, although they typically support operations on smaller, partial words or even bits. For example, an 8-bit processor has an 8-bit word and normally contains instructions for operating on 4-bit nibbles or single bit quantities; a 32-bit processor has a 32-bit word and normally has instructions that operate directly on 8-bit quantities.

Digit-serial computation involves performing calculations using incomplete numbers, or performing computations in a piecemeal fashion. The digit size may be any number of bits—a digit size of one is referred to as “bit-serial”. The complete number is composed of a number of digits.

The first step in dealing with numbers that require more than one processor word to represent them is to decide on their representation. One solution would be to create a structure that consists of a length or digit count, followed by a list of digit data in a predetermined order, such as least significant digit first. The length or digit count could consist of one or more digits. The actual digit data would then be appended to it in memory, occupying adjacent memory locations. A number that needed N processor words or digits of precision, using a single processor word or digit for the length or digit count, would require N+1 total memory words. Registers would need to be allocated to store the total digit count, as well as the working digit count.

This scheme works quite well and is widely used. Operations that deal with multiple digits then require looping program structures over the digit count or length. When using word sizes that only require only one or two digits, this scheme is very inefficient. For example, single digits would require twice the number of digits to represent it. This is less of an issue with much larger word sizes.

A distinction should be made between storing, processing, and communicating numbers of arbitrary precision. While a number of storage schemes are possible, this invention mainly deals with the efficient processing and communication of variable precision numbers.

Another possible method of representing multi-digit words would involve using two words-per-word. The first word would serve as a marker signifying whether the next word or digit was a) the first digit of a number, b) a continuation, or inner digit of a number, or c) the last digit of a number. The second word of this double-word system would contain the actual numeric value. Using this method may eliminate the need to loop over the entire number of words before progressing, thus reducing latency. The additional expense is a doubling of internal and external storage, and a halving of communication or I/O bandwidth. Therefore, a number that needed N processor words of precision would require 2N processor words in memory to represent it.

A processor with a smaller internal word size, associated registers, paths, I/O and ALU would be smaller and faster than one with a larger word size. Numbers of arbitrary size and precision could also be easily handled. An additional benefit of digit-serial processors is that the I/O bus size can be a narrower, fixed size providing a consistent interface that supports various word sizes. Maintaining a consistent and efficient variable precision interface is particularly important when there are multiple processors with fixed communication channels.

Most processors have a fixed word size, based on the number of bits they contain. A variable precision processor deals with words that have an arbitrary number of digits. This is accomplished by providing the necessary hardware support in various areas of the architecture.

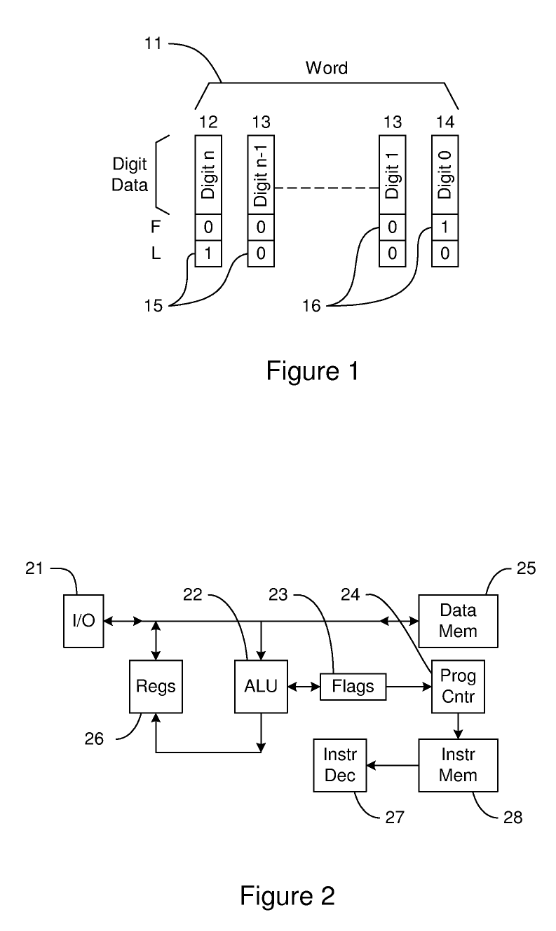

A digit-serial word is shown in FIG. 1. A digit is a collection of bits, similar to a word. For a given implementation, the digit size would be fixed. For the preferred embodiment, the digit size was chosen to be 8-bits, as a reasonable tradeoff for flexibility and efficiency. A word 11 is composed of one or more digits. Flags bits are applied as tags to each digit to signify the position of the digit within the overall word. The F flag bit 16 signifies that the digit is the first digit 14 of a word, while the L flag bit 15 signifies that the digit is the last digit 12 of a word.

Table 1 lists the flag bit combinations which are possible. Continuation digits 13 that are in the middle portion of a word which is greater than two digits do not have either flag bit set. By definition, if both flag bits are set, then the word consists of a single digit. Note that the F and L flag bits only mark the first and last digits of the word, independent of the digit significance. In other words, the least significant digit may be sent/received first, or the most significant digit may be sent/received first. The convention in the preferred embodiment is to use the least significant digit first. If word significance is intermixed, it may be desirable to include an additional flag to specify which ordering is applied to each word. Busses and interconnects, as well as processors and other devices, may utilize digit data with associated word position flag bits to communicate variable precision data.

TABLE 1
Flags Bits

| F | L | Digit Type |
|---|---|---|
| 0 | 0 | Continuation digit |
| 0 | 1 | Last digit |
| 1 | 0 | First digit |
| 1 | 1 | Single digit word |

As an example, consider a word size of 4 digits, with the hexadecimal number 0x1234 (4660 decimal). Following the LSB first convention, the first digit would be 0x4 and the last digit would be 0x1, as shown in Table 2.

TABLE 2
Example

| Hex | Binary | F | L |
|---|---|---|---|
| 4 | 0100 | 1 | 0 |
| 3 | 0011 | 0 | 0 |
| 2 | 0010 | 0 | 0 |
| 1 | 0001 | 0 | 1 |

The use of two flag bits results in a simple and consistent implementation. One alternative to using two flag bits is to only transmit the L flag, and keep the previous value associated with that word. In this case, the previous L flag value becomes the new F flag. In other words, it is implied that, when a digit is the last digit in a word, the next digit is the first digit of the next word. If this scheme is used to keep the previous L flag for each word location and each register, then there would be no real register savings, plus there is the added single digit latency to fully resolve the condition.

While there are many possible variations of processors, and many different implementations of this invention, an exemplary general-purpose architecture is shown in FIG. 2 for the purpose of explanation. Note that in specific variations or embodiments, some of the blocks shown in the figure may not be used and so are eliminated. In others, blocks may be expanded or there may even be additional ones added.

I/O module 21 provides an interface mechanism to another processor or external peripherals. The data and associated tag bits are made available at this interface. When connecting to conventional fixed word architectures, conversion may be required. The registers 26 provide storage for working data, which includes digits and associated tag bits as a single item per register. The arithmetic-logic unit (ALU) 22 performs logic or arithmetic operations on register data; the results are then returned to registers. The flags 23 are used to store certain output conditions from the ALU, and may be used later, for example, as input for subsequent ALU operations, or as condition codes for program counter jump conditions. There is memory that is used for auxiliary data storage 25, and also some for program instruction storage 28. It is possible for some implementations to combine both memories into a single memory for use as both data and program memory, while in the preferred embodiment they are separate. A program counter 24 provides addresses for the program memory. An instruction decoder 27 receives the program instructions and decodes them, providing signals for control logic.

The registers 26 store working data that may come from data memory, input from the I/O module, or ALU output. The data in the registers may be used as input to the ALU for computations, used to store output from the I/O module, or written to data memory. The number of registers may vary based on the implementation, but the number of bits per register is the digit size plus 2 additional bits needed to hold the F and L flags. Specific instructions often specify source or destination registers for their operations.

The arithmetic-logic unit (ALU) 22 performs operations on register data, and normally places the results back into other specified registers. Operations typically include a variety of logic operations such as “and” and “or”, arithmetic operations such as “add” and “subtract”, and shift operations such as “shift left” or “shift right”. The selected operation is decoded from the current instruction by the instruction decoder 27.

Aside from the results of operations that are placed in registers, status flags are sometimes updated, depending on the selected operation. The current status flags are stored in the flag registers 23. Status flags may contain information regarding things such as addition or shift overflows, the sign of the result, or any number of similar indicators. An example of common flag bits could include C (carry), Z (zero), and N (negative), F (first digit), and L (last digit). For certain selected operations, the flag registers are used as inputs to the ALU as part of the current operation. The flags provide state information that may be individually set by the ALU when selected operations are performed, and may be used as input (from previous operations) by the ALU for selected operations. The program counter 24 also uses the status flag registers for conditional jumps.

Consider the case of addition. Two operands that are supplied from registers are added together, with the result being placed into a specified destination register. If the F bit is set, indicating that this is the first digit of a word, then only the two digits are added together, producing a sum digit and a carry output which is saved in the C flag. If the F bit is not set, then the C bit is added to the two operand digits as well, still producing the sum digit and the carry output flag.

As another example, consider the use of signed digit operands and the interpretation of the sign bit, which is the most significant bit of the word. Detecting the MSB of a word involves inspecting the L flag bit and using it to qualify the MSB of the current digit. Virtually every ALU operation, with the exception of the pure Boolean ones, relies on interpreting the F and L bits. Together, the F and L bits define boundary conditions within the ALU that are critical for producing the correct result when operating on partial words.

The program counter 24 provides addresses for the instruction memory 28, which in turn provides the data resident at that address to the instruction decoder 27. It is the address sequence generated by the program counter that represents the instruction sequence executed by the processor. In-line or sequential code or instructions refer to the simple incrementing of the program counter through sequential addresses. While this happens a great deal, to be of practical use, program jumps must be provided. This provides an abrupt change from the normal sequential flow of the instruction memory addresses.

Both condition and non-conditional jump instructions are provided. If it is conditional, then the specified condition must be true for the new program counter address to take affect. If not, then execution continues with the next sequential instruction. The condition is specified as an instruction argument. In general, the conditions consist of flag register values, or combinations of values. Example conditions include, but are not limited to:
Equal to zero (Z=0)
Not equal to zero (Z!=0)
End of word (L=1)
Beginning of word (F=1)

One method of specifying the new, non-sequential program counter address for the jump instruction is to provide it as an argument with the instruction itself. Alternatively, a signed displacement of limited range may be specified. If the condition is true (or if an unconditional jump is specified), the signed value is added to the current address value, generating the new next instruction address. Generally the signed displacement range is much smaller than the address range of the instruction memory, and it is used because it occupies fewer bits, thus saving space in the instruction word.

The instruction memory 28 need not be separate from the data memory 25. The width of the instruction memory is generally a multiple of the instruction word width. The memory may be fixed or non-volatile, as in read-only memory, or it may be read-write memory. Non-volatile memory may be fixed during the manufacturing process, via a metal or diffusion mask step, or may be alterable, as in flash memory, and be written by an external mechanism. In any event, it serves as the program storage facility for the instruction sequence of the processor. The size of the instruction memory is very dependent on the intended application, or instantiation. The only requirement is that be large enough to hold the necessary program instructions.

The data memory 25 is an optional, but common element. For applications with minimal data storage requirements, the data memory may be eliminated, with only registers being used for that purpose. Alternatively, the data memory may be merged with the instruction memory. Note that if the instruction memory is read-only, that implies that the data memory may only be used to store constants. The data memory may be used to hold state information for context switches—things like the register contents, status flags, program counter, and other necessary information. Another common use of the data memory is for stacks, queues, or look-up tables. Instructions are provided that allow registers read or write access to the data memory. Addressing may also be performed by one of the registers.

The I/O module 21 provides a means for communicating with peripherals and expansion devices or interfaces. Data moves to or from the I/O module through the registers, under program control. Other widely used methods of moving data to or from memory, such as direct-memory-access (DMA) may also be employed. The I/O module may interface with peripherals (or other processors) that understand variable precision, or it may interface with devices that do not. Variable precision peripheral devices would accept and provide the additional flag bits that signify the digit position within the word.

Peripherals that do not understand variable precision words must have the data mapped to their word size. One method of doing this would involve adding additional bits (or digits) to extend the width if the peripheral word size is larger, or truncating bits (or digits) if the peripheral word size were smaller. Decisions regarding left or right justification need me made. Other mapping methods may be created that do not involve the truncation of data, based on a predefined protocol or addressing techniques.

One possible method of performing this operation is used in the preferred embodiment, where the I/O module is 32-bits wide, while the processor digit size is 8-bits. The I/O module has a conventional, non-variable precision bus with 32-bit data bits and independent byte enables. To provide a straightforward mechanism for setting the digit position tag bits, aliases of the register or memory addresses are provided. There are four views made available. The aliases for I/O module writes are shown in Table 3 and those for reads are shown in Table 4.

TABLE 3
Write Aliases

| Alias | Byte 3 | Byte 2 | Byte 1 | Byte 0 |
|---|---|---|---|---|
| 1 | F, L, Data | F, L, Data | F, L, Data | F, L, Data |
| 2 | L, Data | F, Data | L, Data | F, Data |
| 3 | L, Data | Data | Data | F, Data |
| 4 | Data | Data | Data | Data |

TABLE 4
Read Aliases

| Alias | Byte 3 | Byte 2 | Byte 1 | Byte 0 |
|---|---|---|---|---|
| 1 | Data | Data | Data | Data |
| 2 | F | F | F | F |
| 3 | L | L | L | L |
| 4 | Data | Data | Data | Data |

As noted above, the digit size in the embodiment being discussed is 8-bits. For I/O interface write operations, the first alias allows the writing of data with word sizes of 8-bits while setting the F and L bits automatically. A second alias is provided for writing a 16-bit word while setting the flag bits, and a third one is for writing 32-bit word sizes. The fourth alias allows the writing of data while setting the F and L bits to zero, which is useful for loading words greater than 32-bits. Larger word sizes may be written by handling the endpoint byte by writing byte 0 to alias 1, followed by writes to alias 4. Finally, the ending byte needs to be written to alias 1.

The I/O read aliases provide a mechanism to read the F bits, the L bits, and the data bits separately. Alias 1 and 4 are identical and return only the data associated with the read address. Alias 2 returns the F flag in the lower bit position of each byte, while alias 3 returns the L flag in the lower bit position of each byte. Data is not returned when reading from alias 2 and 3. Those aliases are only used to determine digit alignment.

Those of skill in the art will understand that information and signals may be represented using any of a variety of different technologies and techniques. For example, data, instructions, commands, information, signals, bits, symbols, and the like that may be referenced throughout the above description may be represented by voltages, currents, electromagnetic waves, magnetic fields or particles, optical fields or particles, or any combination thereof. The information and signals may be communicated between components of the disclosed systems using any suitable transport media, including wires, metallic traces, vias, optical fibers, and the like.

Those of skill will further appreciate that the various illustrative logical blocks, modules, circuits, and algorithm steps described in connection with the embodiments disclosed herein may be implemented in various ways. To clearly illustrate this variability of the system's topology, the illustrative components, blocks, modules, circuits, and steps have been described above generally in terms of their functionality. Whether such functionality is implemented in the particular functional blocks specifically described above depends upon the particular application and design constraints imposed on the overall system and corresponding design choices. Those of skill in the art may implement the described functionality in varying ways for each particular application, but such implementation decisions should not be interpreted as causing a departure from the scope of the present invention.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A system comprising:
a variable precision processor;
wherein one or more internal structures of the processor are configured to internally represent a variable precision data word as a variable number of digits, wherein each digit includes a digit value and one or more associated tags indicative of the digit's position within the data word.

2. The system of claim 1, wherein the tags associated with each digit include a first tag indicative of whether the digit is the first digit in the data word, and a last tag indicative of whether the digit is the last digit in the data word.

3. The system of claim 2, wherein each tag comprises a single bit.

4. The system of claim 3, wherein:
if the first tag bit is set and the last tag bit is not set, the digit is the first digit of a multi-digit data word;
if the first tag bit is not set and the last tag bit is set, the digit is the last digit of the multi-digit data word;
if neither the first tag bit nor the last tag bit is set, the digit is an intermediate digit of the multi-digit data word; and
if both the first tag bit and the last tag bit are set, the digit comprises a single-digit data word.

5. The system of claim 1, wherein the digit value comprises an 8-bit value.

6. The system of claim 1, further comprising one or more devices which are external to the processor and which are coupled to the processor, wherein the devices are configured to process the variable precision data word as fixed precision data.

7. The system of claim 6, wherein the devices include a conventional memory, wherein the conventional memory is configured to store the digit value without the associated tags.

8. The system of claim 7, wherein the processor is configured to write to the conventional memory using aliases that map the digit values of the variable precision data word to corresponding portions of the conventional memory.

9. The system of claim 7, wherein the processor is configured to read from the conventional memory using aliases that map portions of the conventional memory to the digit values of the variable precision data word, and that set the tags associated with the digits.

10. The system of claim 1, wherein the internal structures of the processor include one or more registers configured to store the digits of the variable precision data word and the associated tags.

11. A method implemented in a variable precision processor comprising:
within the variable precision processor,
representing a variable precision data word as a variable number of digits, wherein each digit includes a digit value and one or more associated tags indicative of the digit's position within the data word, and
processing the data word in a digit-serial fashion.

12. The method of claim 11, wherein the tags associated with each digit include a first tag indicative of whether the digit is the first digit in the data word, and a last tag indicative of whether the digit is the last digit in the data word.

13. The method of claim 12, wherein each tag comprises a single bit.

14. The method of claim 13, further comprising:
if the digit is the first digit of a multi-digit data word, setting the first tag bit and not setting the last tag bit;
if the digit is the last digit of the multi-digit data word, not setting the first tag bit and setting the last tag bit;
if the digit is an intermediate digit of the multi-digit data word, not setting the first tag bit and not setting the last tag bit; and
if the digit comprises a single-digit data word, setting both the first tag bit and the last tag bit.

15. The method of claim 11, wherein the digit value comprises an 8-bit value.

16. The method of claim 11, further comprising transferring the data word in a digit-serial fashion between the processor and one or more devices which are external to the processor, wherein the devices are configured to process the variable precision data word as fixed precision data.

17. The method of claim 16, wherein the devices include a conventional memory, further comprising storing the digit value in the conventional memory without the associated tags.

18. The method of claim 17, further comprising the processor writing the variable precision data word to the conventional memory using aliases that map the digit values of the variable precision data word to corresponding portions of the conventional memory.

19. The method of claim 17, further comprising the processor reading from the conventional memory using aliases that map portions of the conventional memory to the digit values of the variable precision data word, and setting the tags associated with the digits.

20. The method of claim 11, further comprising storing the digits of the variable precision data word and the associated tags in one or more registers internal to the processor.
